(19) United States
(12) Patent Application Publication
(10) Pub. No.: US 2014/0114500 A1
(43) Pub. Date: Apr. 24, 2014

(54) METHOD AND SYSTEM FOR ADJUSTING SIDE MIRROR

(71) Applicant: HYUNDAI MOTOR COMPANY, Seoul (KR)

(72) Inventor: Dong Gyu Noh, Dongducheon (KR)

(73) Assignee: HYUNDAI MOTOR COMPANY, Seoul (KR)

(21) Appl. No.: 13/693,580

(22) Filed: Dec. 4, 2012

(30) Foreign Application Priority Data
Oct. 23, 2012 (KR) 10-2012-0118108

(51) Int. Cl. B60R 1/00

(52) U.S. Cl. CPC B60R 1/007
USPC 701/2

(57) ABSTRACT

A method and system for adjusting a side mirror. The method includes determining, by a controller using an in-vehicle radio communication device, when an application vehicle is near an intersection, determining, by the controller using the in-vehicle radio communication device, when a second vehicle is located in a danger zone, calculating, by the controller including a memory and a processor, a mirror zone, wherein the mirror zone is an area visible in a side mirror, based on an angle between a driver and the side mirror, and adjusting, by the controller, an angle of the side mirror so the second vehicle is visible in the mirror zone when the second vehicle is located in the danger zone.

### CROSS-REFERENCE

This application claims under 35 U.S.C. §119(a) the benefit of Korean Patent Application No. 10-2012-0118108 filed on Oct. 23, 2012, the entire contents of which are incorporated herein by reference.

### BACKGROUND OF THE INVENTION

1. Field of the Invention

The present invention relates to a method and system for adjusting a side mirror which adjusts the angle of the side mirror using vehicle-to-X (V2X) communication.

2. Description of the Related Art

Recently, in response to the development of radio communication technologies, vehicle-to-infrastructure antenna (V2I) communication technology which enables communication between a vehicle (V) and an infrastructure antenna (I) (see FIG. 1), vehicle-to-vehicle (V2V) communication technology which enables communication between vehicles (V) (see FIG. 2), and V2X communication technology which enables both V2I communication and V2V communication have been proposed.

A variety of functions which use such technologies can be provided in vehicles. The present invention relates to optimum adjustment of a side mirror using the V2X communication technology.

Recently, some technologies having systems which automatically adjust side mirrors of a vehicle have been introduced. Among them, Korean Patent Application Publication 10-2000-0033489 A discloses side mirror control using a gyro sensor. According to this application, when a vehicle enters an intersection, a side mirror is adjusted following the angle of rotation of the gyro sensor so the side mirror remains in the direction in which the vehicle travels to prevent a potential accident from an obstructed or a dead angle.

However, this technology can be applied only when the vehicle makes a turn, and thus it may difficult to apply this technology at an intersection in which the vehicle does not turn. In to addition, when the gyro sensor is used, when a second vehicle drives irregularly, it may be difficult to view the other vehicle in the side mirror.

Therefore, there an advanced technology that can effectively view a second vehicle on the side mirror using V2X communication is proposed.

The foregoing is intended merely to aid in the understanding of the background of the present invention, and is not intended to mean that the present invention falls within the purview of the related art that is already known to those skilled in the art.

### SUMMARY OF THE INVENTION

The present invention provides a method and system for adjusting a side mirror which optimally adjusts the angle of the side mirror using V2X communication to provide a driver with a wider field of vision and prevent an accident at an intersection.

According to one embodiment of the present invention, the method includes: determining, by a controller using an in-vehicle radio communication device, when a first vehicle is in close proximity of an intersection via; detecting, by the controller using the in-vehicle radio communication device, a second vehicle in a danger zone; calculating, by the controller including a memory and a processor, a mirror zone which is an area viewed by a side mirror, based on an angle between a driver and the side mirror; and adjusting, by the controller, an angle of the side mirror so the second vehicle is visible in the mirror zone when the second vehicle is located in the danger zone.

Additionally, the controller, using the in-vehicle radio communication device, may recognize a predetermined area of a first traffic lane along which the first vehicle travels which is near the to intersection as a merging point and determine a close proximity to the intersection by determining that the first vehicle is located at the merging point. Furthermore, the in-vehicle radio communication device may communicate between the first vehicle and an infrastructure antenna (V2I communication). The close proximity of the first vehicle to the intersection may be based on a communication of the vehicle with a global positioning system (GPS) and information from a navigator.

The danger zone may be a predetermined area of a second lane near the intersection which the first vehicle may be traveling into. The controller using the in-vehicle radio communication device may determine that the second vehicle is located in the danger zone from a V2I communication between a vehicle and an infrastructure antenna or V2V communication between vehicles. When the second vehicle is determined to not be in the danger zone, the controller, using the in-vehicle radio communication device, may detect when the second vehicle is located in close proximity to the danger zone.

The processor may calculate the mirror zone based on an angle between a position of a driver and a side mirror.

The system of the present invention may include a communication device which performs radio communication with an infrastructure antenna or a second vehicle; a controller including a memory and a processor which adjusts an angle of a side mirror; calculates a mirror zone that is visible in the side mirror based on an angle between a driver and the side mirror, determines when a first vehicle is near an intersection and determines when a second vehicle is located in a danger zone, and adjusts the side mirror so the second vehicle is visible in the mirror zone when the second vehicle is located in the danger zone.

According to embodiments of the invention, the method and system for adjusting a side to mirror may adjust the angle of the side mirror using V2X communication to provide the driver with substantially wider field of vision and prevent a potential accident at an intersection.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is an exemplary configuration of vehicle-to-infrastructure antenna (V2I) communication, according to the related art;

FIG. 2 is an exemplary configuration of vehicle-to-vehicle (V2V) communication, according to the related art;

FIG. 3 is an exemplary diagram illustrating a method for adjusting a side mirror, according to an exemplary embodiment of the invention;

FIG. 4 is an exemplary diagram illustrating a system for adjusting a side mirror according to an exemplary embodiment of the invention; and

FIG. 5 is an exemplary flowchart of a method for adjusting a side mirror according to an exemplary embodiment of the invention.

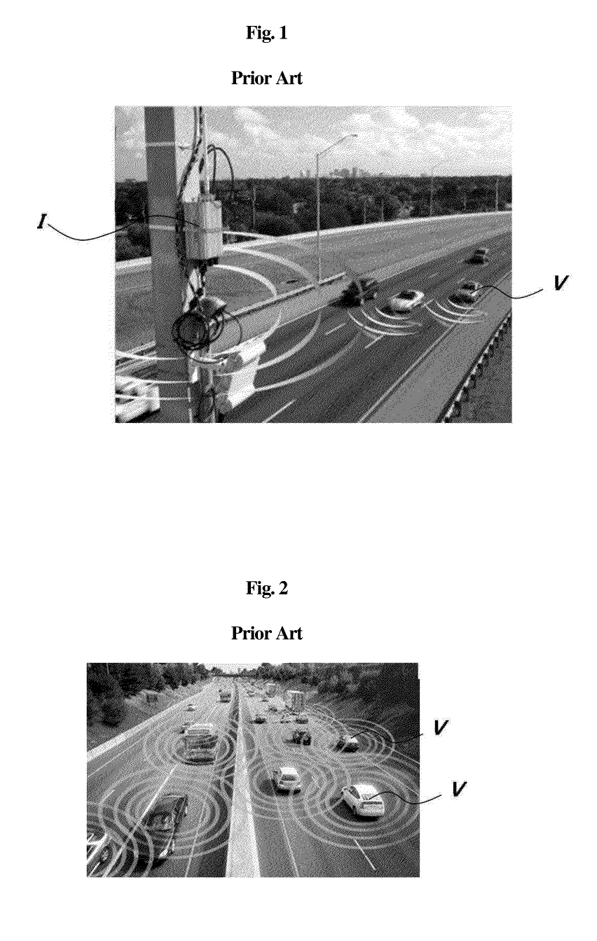

### DETAILED DESCRIPTION OF THE INVENTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Additionally, it is understood that the term controller refers to a hardware device that includes a memory and a processor. The memory is configured to store the modules and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other to features, integers, steps, operations, elements, components, and/or groups thereof. As used herein, the term “and/of” includes any and all combinations of one or more of the associated listed items.

Hereinafter, a method and system for adjusting a side mirror according to exemplary embodiments of the present invention will be described in detail with reference to the accompanying drawings.

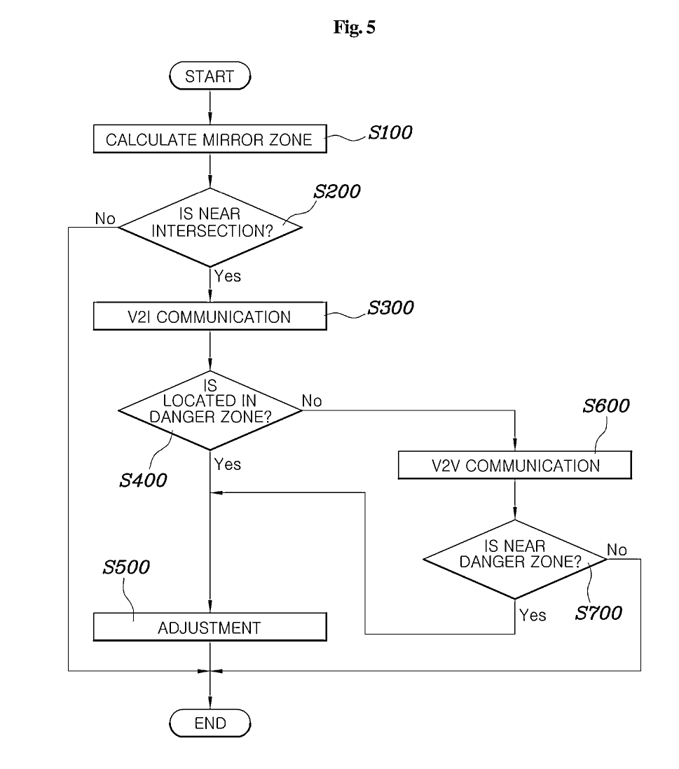

FIG. 5 is an exemplary flowchart of a method for adjusting a side mirror according to an exemplary embodiment of the invention. The method for adjusting a side mirror of this embodiment includes determining, by a controller using an in-vehicle radio communication device, when a first vehicle to the method is applied is near an intersection (S200), determining, by the controller using the in-vehicle radio communication device, when a second vehicle is located in a danger zone (S400), calculating, by the controller including a memory and a processor, a mirror zone, a zone that visible by a side mirror, based on the angle between a driver and the side mirror (S100), and adjusting, by the controller, the angle of the side mirror so the second vehicle is visible in the mirror zone when the second vehicle is located in the danger zone (S500).

The method for adjusting a side mirror of this embodiment is an adjustment method using a vehicle-to-X (V2X) communication, and is proposed to avoid a potentially dangerous situation, mainly, at an intersection. At the intersection, it may be difficult to view all surrounding areas using the side mirror as the application vehicle enters the intersection and when an unforeseeable circumstance in which a second vehicle changes a traffic lane occurs. Therefore, when entering the intersection, the driver is confronted with a difficult circumstance in which he or she must watch both the rear and front of the vehicle.

In addition, at the intersection, information from a navigator may not include a lane change of the vehicle, attributable to the limit of the GPS communication. Thus, such circumstances at the to intersection require more accurate communication and adjustment of the side mirror.

Therefore, the system for adjusting a side mirror according to an embodiment of the invention may include a communication device 120 which may communicate with an infrastructure antenna (I) or a second vehicle (X) 300, a controller 150 controlling a drive module 142 which may adjust the angle of the side mirror 140. The controller 150, including a memory and a processor, may calculate a mirror zone 144 visible in the side mirror 140 based on the angle between a driver H and the side mirror 140, determine when a first vehicle 100 to which the system is applied is near an intersection and determine when a second vehicle 300 is located in a danger zone 620, and control the drive module 142 so the second vehicle 300 is visible in the mirror zone 144 when the second vehicle 300 is located in the danger zone 620.

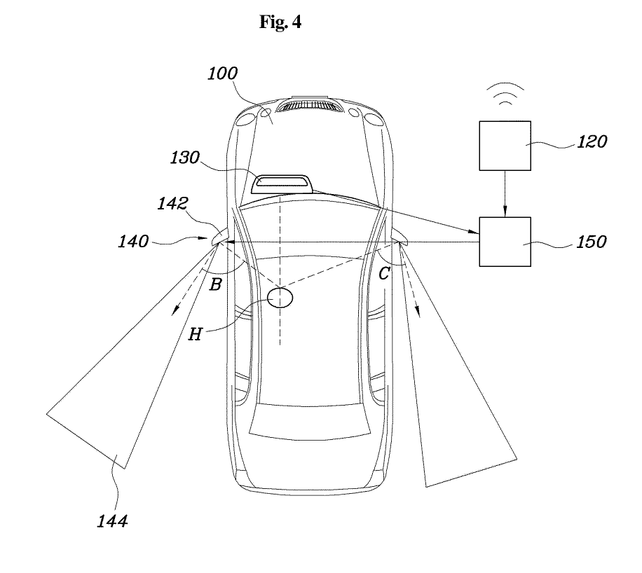

FIG. 4 is an exemplary configuration illustrating the system for adjusting a side mirror according to an embodiment of the invention. Referring to FIG. 4, the first vehicle comprises the communication device 120 which may communicate with other vehicles (X) or the infrastructure antenna (I) and the drive module 142, controlled by the controller 150, which may adjust the angle of the side mirror.

In addition, the controller 150 of the vehicle may calculate the mirror zone 144, which is the area visible in the side mirror 140, based on the angle between the driver H and the side mirror 140. Moreover, the position of the driver H may be more accurately located using a camera 130 which photographs the interior of the first vehicle although the position of the driver H may be assumed to be the center of a seat. Further, the mirror zone 144 which is the area reflected on the side mirror 140 may be calculated based on the angle B or C of the driver H with respect to the side mirror 140.

Additionally, the controller 150 may determine when the first vehicle 100 is near the intersection using the communication device, and may determine when the second vehicle 300 is to located in the danger zone 620. When the second vehicle 300 is located in the danger zone 620, the controller 150 may control the drive module 142 so the second vehicle 300 may be visible in the mirror zone 144.

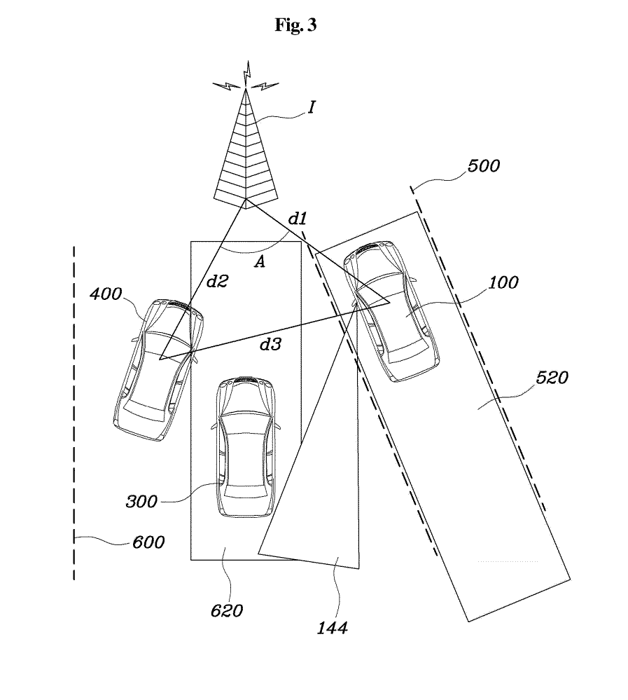

Specifically, FIG. 3 is an exemplary diagram illustrating the method for adjusting a side mirror according to an embodiment of the invention. Referring to FIG. 3, under the assumption that an intersection exists on the road and the first lane 500 that the first vehicle 100 drives along merges with a second lane 600 along which the second vehicle 300 drives, the mirror zone 144 of the first vehicle 100 may be calculated by the above-described method. After determining that the first vehicle 100 has entered a merging point 520 which is near the intersection, the location of the second vehicle 300 may be viewed through the side mirror.

When the second vehicle 300 has entered the danger zone 620 of the second lane 600 which is near the intersection, the side mirror may be adjusted to follow the second vehicle 300. Specifically, the correct relative position between the first vehicle 100 and the second vehicle 300 must be calculated. Further, both the first vehicle 100 and the second vehicle 300 may communicate with the infrastructure antenna (I), and thus the distance (d1) between the first vehicle 100 and the infrastructure antenna (I), the distance (d2) between the second vehicle 300 and the infrastructure antenna (I), the distance (d3) between the vehicles 100 and 300, and the angle between the vehicles 100 and 300 may be determined. Accordingly, the position of the second vehicle 300 may determined, and the side mirror of the first vehicle 100 may be adjusted so the second vehicle visible in the mirror zone 144.

FIG. 5 is an exemplary flowchart of the method for adjusting a side mirror according to an embodiment of the invention. Referring to FIG. 5, the method for adjusting a side mirror of this to embodiment includes determining, by a controller using an in-vehicle radio communication device, when a first vehicle is near an intersection (S200), determining, by the controller using the in-vehicle radio communication device, when a second vehicle is located in a danger zone (S400), calculating, by the controller including a memory and a processor, a mirror zone, which is a zone visible in a side mirror, based on an angle between a driver and the side mirror (S100), and adjusting, by the controller the angle of the side mirror so the second vehicle is visible in the mirror zone when the second vehicle is located in the danger zone (S500).

In addition, the step S200 which determines when the first vehicle is near the intersection may detect, by the controller, a predetermined area of a first lane along which the first vehicle drives which is near the intersection as a merging point, and may determine, by the controller, when the first vehicle is near the intersection by determining when the first vehicle is located at the merging point.

Furthermore, in determining when the first vehicle is near the intersection, the in-vehicle radio communication device may communicate via a V2I communication which is a type of communication between a vehicle and an infrastructure antenna. Alternatively, the controller may determine when the first vehicle is near the intersection based on a communication of the first vehicle with a global positioning system (GPS) and information from a navigator.

When the application vehicle is near the intersection, the position of the second vehicle may be determined by the controller via V2I communication (S300), and when the second vehicle is located in the danger zone may be determined similarly by the controller (S400). In addition, the position of the second vehicle may be determined via V2V communication (S600), and when the second vehicle is positioned in the danger zone (S700) may similarly be determined. These communication methods may be useful when the infrastructure antenna malfunctions or is absent.

After the second vehicle is detected by the controller via the V2X communication, a trace and a present position of the second vehicle may be determined by calculating the related communication data. Specifically, when the first vehicle merges with the second lane, a predetermined area of the second lane which is near the intersection, may be set as the danger zone which is a reference for detection of the second vehicle.

The method further includes the step S700 of determining, by the controller, when the second vehicle is near the danger zone. Additionally, the controller may adjust the mirror of the side mirror when the second vehicle is near the danger zone. A third vehicle 400 which may change lane, as shown in FIG. 3, may be classified as a high risk vehicle so the second vehicle may be visible the side mirror. This situation may not be performing based on information only from the navigator. In particular, the present invention has a substantially higher execution precision than when the second vehicle is detected using radar equipment when the presence of an obstacle is assumed. In general, an obstacle such as a tree may be present between intersections in a mountainous place.

Additionally, the step S500 of adjusting the angle of the side mirror so the second vehicle is visible in the mirror zone when the second vehicle is located in the danger zone may be performed so the second vehicle may be visible in the side mirror, thereby promoting safe driving. In particular, it may be possible to correctly predict the second vehicle via V2X communication when the second vehicle abruptly changes traffic lanes and enters the first lane along which the first vehicle is traveling, when the second vehicle enters the lane quickly because it is driving fast, or when an obstacle is present at the intersection.

Although a exemplary embodiment of the present invention has been described for illustrative purposes, those skilled in the art will appreciate that various modifications, additions and to substitutions are possible, without departing from the scope and spirit of the invention as disclosed in the accompanying claims.

What is claimed is:

1. A method for adjusting a side mirror, comprising:
determining, by a controller using an in-vehicle radio communication device, when a first vehicle is near an intersection;
determining, by the controller using the in-vehicle radio communication device, when a second vehicle is located in a danger zone;
calculating, by the controller, a mirror zone, wherein the mirror zone is an area visible in a side mirror, based on an angle between a driver and the side mirror; and
adjusting, by the controller, an angle of the side mirror so the second vehicle is visible in the mirror zone when the second vehicle is located in the danger zone.

2. The method of claim 1, wherein determining when the first vehicle is near the intersection further comprises:
recognizing, by the controller, a predetermined area of a lane near the intersection as a merging point along which the first vehicle drives; and
determining, by the controller, when the first vehicle is near the intersection by determining when the first vehicle is located at the merging point.

3. The method of claim 1, wherein the in-vehicle radio communication device communicates via a vehicle-to-infrastructure antenna (V2I) communication between the vehicle and an infrastructure antenna.

4. The method of claim 1, wherein determining, by the controller, is based on communication of the vehicle with a global positioning system and information from a navigator.

5. The method of claim 1, wherein the danger zone is a predetermined area of a second lane which is near the intersection,

6. The method of claim 1, wherein determining, by the controller, when the second vehicle is located in the danger zone further comprises:
determining, by the controller, a position of the second vehicle via the V2I communication; and
determining, by the controller, when the second vehicle is located in the danger zone.

7. The method of claim 1, wherein determining, by the controller, when the second vehicle is located in the danger zone further comprises:
determining, by the controller, a position of the second vehicle via a vehicle-to-vehicle (V2V) communication between vehicles; and
determining, by the controller, when the second vehicle is located in the danger zone.

8. The method of claim 1, wherein determining, by the controller, when the second vehicle is located in the danger zone further comprises:
determining, by the controller, when the second vehicle is near the danger zone; and
adjusting, by the controller, the angle of the side mirror when the second vehicle is near the danger zone.

9. The method of claim 1, wherein calculating, by the controller, the mirror zone further comprises: calculating, by the controller, the mirror zone based on an angle between a position of a driver and the side mirror.

10. A system for adjusting a side mirror, comprising:
a communication device configured to communicate with an infrastructure antenna;
a controller, including a memory and a processor, configure to:
control a drive module to adjust an angle of a side mirror;
calculate a mirror zone viewable by the side mirror based on an angle between a driver and the side mirror
determine when a first vehicle is near an intersection;
determine when a second vehicle is located in a danger zone; and
control the drive module so the second vehicle is visible in the mirror zone when the second vehicle is located in the danger zone.

11. The system of claim 10, wherein the communication device is configured to communicate with a second vehicle.

12. A non-transitory computer readable medium containing program instructions executed by a processor or controller, the computer readable medium comprising:
program instructions that control a drive module to adjust an angle of a side mirror;
program instructions that calculate a mirror zone viewable by the side mirror based on an angle between a driver and the side mirror;
program instructions that determine when a first vehicle is near an intersection;
program instructions that determine when a second vehicle is located in a danger zone; and
program instructions that control the drive module so the second vehicle is visible in the mirror zone when the second vehicle is located in the danger zone.

13. The non-transitory computer readable medium of claim 12, further comprising program instructions that control a drive module to adjust an angle of a side mirror based on a communication with a second vehicle.

14. The non-transitory computer readable medium of claim 12, further comprising program instructions that control a drive module to adjust an angle of a side mirror based on a communication with an infrastructure antenna.
